(19) United States
(12) Patent Application Publication
(10) Pub. No.: US 2008/0113167 A1
(43) Pub. Date: May 15, 2008

(54) COLOR TOOLS AND METHODS FOR COLOR MATCHING

(75) Inventor: Michael J. Henry, Hinckley, OH (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/930,898

(22) Filed: Oct. 31, 2007

Related U.S. Application Data
(60) Provisional application No. 60/865,255, filed on Nov. 10, 2006.

(51) Int. Cl. B32B 7/02; G01J 3/52

(52) U.S. Cl. 428/212; 356/421

(57) ABSTRACT

Tools for matching the color of a coating on an article are disclosed. These tools include (a) a color chip that includes a coating exhibiting gonio-apparent properties; and (b) a window disposed directly adjacent to at least one side of the color chip, wherein the window has dimensions sufficient for an observer to view the gonio-apparent properties of a coating on an underlying article and compare it to the gonio-apparent properties of the coating on the color chip. Also disclosed are paint chip books that include one or more pages having a plurality of such color tools and method for matching the color of a coating on an article utilizing such color tools.

### CROSS-REFERENCE TO RELATED APPLICATIONS

This application claims the benefit of U.S. Provisional Patent Application Ser. No. 60/865,255, filed Nov. 10, 2006.

### FIELD OF THE INVENTION

The present invention relates to tools that may be used for matching the color of a coating on an article and methods for matching the color of a coating on an article, such as the paint on a vehicle, including a vehicle under repair.

### BACKGROUND INFORMATION

When a damaged car body is repaired, the repair area must often be repainted. It is often critical that the color of the repaired area match that of the rest of the car such that the repair area is not distinguishable to the observer.

One method that is commonly used to assist the repairer in obtaining a color match involves the use of color chips. A color chip is a color coated panel, which represents an available paint color. These chips are often included in a paint chip book that may include, for example, chips for each model year prime color for a variety of vehicle manufacturers.

To obtain a color match using a paint chip book, the repairer may visually examine the available color chips and compare the color to that of the vehicle. To assist the repairer in this process, color chips containing a hole are sometimes provided. Examples of pages from paint chip books that include such paint chips are illustrated in FIGS. 1a and 1b. As is apparent, the color chips provided in these prior art tools contain a hole within the chip. The repairer, therefore, may place the chip against the vehicle body to be repaired and visually compare the color of the vehicle body to the color of the chip. The repairer attempts to identify the best color match and obtains the coating formulation corresponding to the selected color.

Such prior art color chips, however, are often unsatisfactory. As will be appreciated, the coatings on many vehicles include metallic flakes and/or pigments that create interference effects that result in a coating possessing gonio-apparent properties, such that they exhibit the property of angle-dependent color change, i.e., the color changes upon variation of the angle of incident light, or as the viewing angle of the observer shifts.

The prior art color chips included in the paint chip books described earlier are often not suitable for paint color matching when dealing with coatings with gonio-apparent properties, such as is often the case with coatings on vehicle car bodies. In particular, the size and location of the holes in the color chips are not sufficient to enable the repairer to observe and compare the shift in color of the paint chip with the shift in color of the vehicle body to repaired, when both are viewed at various viewing angles. Moreover, the white color of the substrate upon which such chips have been deposited can affect the ability of the human eye to calibrate to the color chip.

As a result, it would be desirable to provide an improved tool for matching the color of a coating exhibiting gonio-chromatic properties, including a color chip and a paint chip book comprising such color chips. It would also be desirable to provide an improved method for matching the color of a coating exhibiting gonio-chromatic properties that utilizes such a tool.

### SUMMARY OF THE INVENTION

In certain respects, the present invention is directed to tools for matching the color of a coating on an article, wherein the coating exhibits gonio-apparent properties. Such tools comprise: (a) a color chip comprising a coating exhibiting gonio-apparent properties; and (b) a window disposed directly adjacent to at least one side of the color chip, wherein the window has a length at least 50% that of the adjacent side of the color chip.

In other respects, the present invention is directed to a paint chip book comprising one or more pages, wherein the pages comprise a plurality of color tools. The color tools comprise: (a) a color chip comprised of a coating exhibiting gonio-apparent properties; and (b) a window disposed directly adjacent to at least one side of the color chip, wherein the window has a length at least 50% that of the adjacent side color chip side.

The present invention is also related to methods for matching the color of a coating on an article, such as a vehicle under repair. The methods comprise: (a) placing a color tool against a surface of the article, the color tool comprising: (i) a color chip comprising a coating exhibiting gonio-apparent properties; and (ii) a window disposed directly adjacent to at least one side of the color chip, wherein the window has a length at least 50% that of the adjacent side of the color chip; and (b) observing the color of the article through the window at a plurality of viewing angles.

The present invention is also related to methods for refinishing the paint on an article, such as a vehicle under repair, utilizing the color tools of the present invention.

### DESCRIPTION OF THE DRAWINGS

FIGS. 1a and 1b illustrate certain color tools of the prior art; and

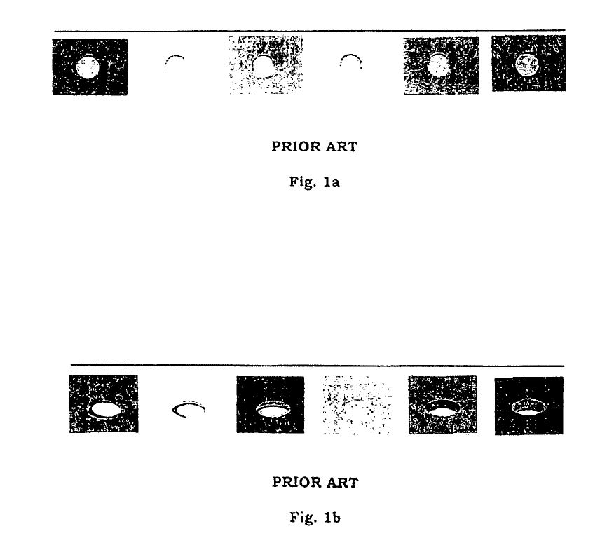

FIG. 2 illustrates a plurality of color tools in accordance with certain embodiments of the present invention.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously mentioned, certain embodiments of the present invention are directed to tools for matching the color of a coating. As used herein, the term “tool” refers to a device used to achieve a desired result. In the present invention, the “desired result” is to match the color of a coating on an article, wherein the coating exhibits gonio-apparent properties. As used herein, the term “gonio-apparent properties” refers to the appearance of a coating that exhibits the property of angle-dependent color change, i.e., the color changes upon variation of the angle of incident light, or as the viewing angle of the observer is shifted.

In certain embodiments, the tools of the present invention comprise a color chip. As used herein, the term “color chip” refers to a color coated panel. The color chips utilized in the present invention are comprised of a coating that exhibits gonio-apparent properties, which may result from, for example, the presence of metallic effect pigments, such as particles of aluminum, zinc, copper, brass, lead, bronze, stainless steel, and the like, and/or the presence of interference pigments, such as pigments that comprise multiple layer of reflective material, e.g., aluminum or chromium, sandwiching layers of dielectric material, e.g., metal fluoride, metal oxide, or magnetic layers, and absorptive layers, e.g., mica or coated mica. In certain embodiments, as illustrated in the Figures herein, such color chips are often, but are not necessarily, in the form of a square or rectangle.

In certain embodiments of the color tools of the present invention, a window is disposed directly adjacent to at least one side of the color chip. As used herein, the term “window” refers to an opening. As used herein, the term “directly adjacent” means that there is no surface or structure between the window and the adjacent side of the color chip so that the observer has an uninterrupted view of the color chip and the underlying article when the color chip is placed against a surface of the article.

In the color tools of the present invention, the window has dimensions sufficient for the observer to view the gonio-apparent properties of the coating on the underlying article and compare it to the gonio-apparent properties of the coating on the color chip. In certain embodiments, therefore, the window has a length of at least 50%, such as at least 75%, or, in some cases, at least 90% or at least 100% of the length of the adjacent side of the color chip. In certain embodiments, the width of the window (the dimension perpendicular to the length) is at least one-third of the length of the window, such as at least 50% of the length of the window.

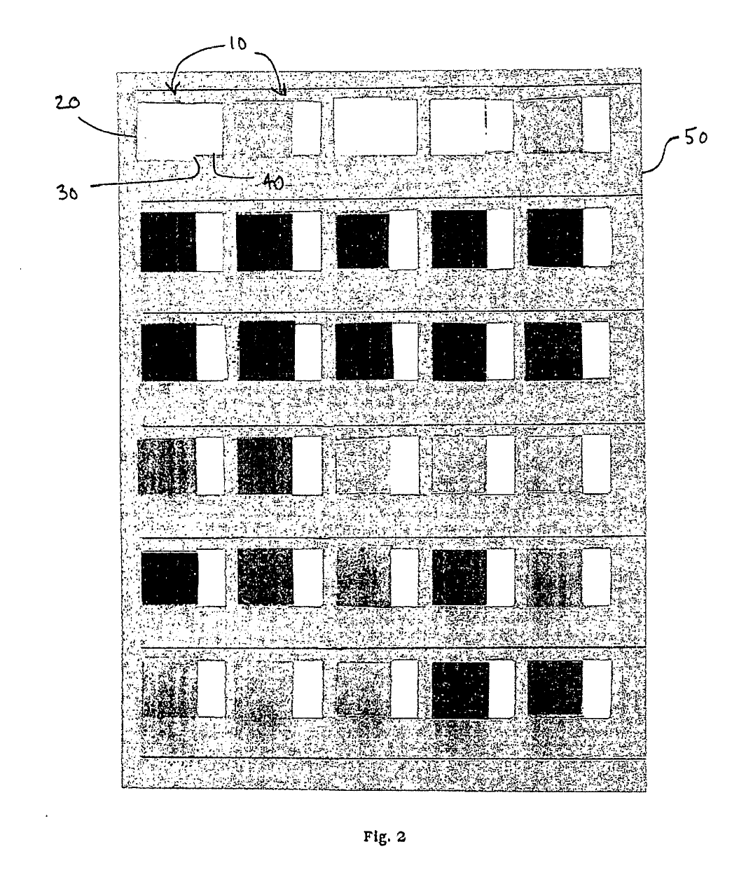

Reference is now made to FIG. 2, wherein a page of a paint chip book comprising a plurality of color tools in accordance with certain embodiments of the present invention is illustrated. As used herein, the term “paint chip book” refers to a set of sheets of paper or other material comprising a plurality of color tools, wherein the sheets are bound together into a volume. In certain embodiments, a “paint chip book” is not a color wheel.

As is apparent, the tools 10 which are depicted comprise a color chip 20 that comprises a coating exhibiting gonio-apparent properties. The color chips, in these embodiments, are in the general form of a square having a side 30 directly adjacent to which is disposed a window 40. In these embodiments, the window 40 has a length about 100% of the length of the side of the color chip to which it is directly adjacent.

Still referring to FIG. 2, it is seen that the page of a paint chip book illustrated therein comprises a plurality of color chips 20 that are deposited upon a substrate 50. The substrate 50 may comprise any suitable material for forming a page of a book, such as paper, plastic, or the like; however, most often the substrate is some type of paper. Moreover, the color of the paper may be any color desired, such as white. In certain embodiments, however, the substrate 50 is, as illustrated in FIG. 2, grey. As used herein, the term “grey” refers to a neutral achromatic, i.e., hueless, color between black and white. Indeed, it has been discovered that the use of a grey substrate for the pages of the color chip books of the present invention allow the human eye to calibrate to the chip color better than color chips presented on a white substrate.

As previously indicated, the present invention is also directed to methods for matching the color of a coating on an article, such as a vehicle, including, for example a vehicle under repair. These methods comprise: (a) placing a color tool of the type previously described against a surface of the article; and (b) observing the color of the article through the window at a plurality of viewing angles. In these methods, after observing the color of the article as previously described the user is then able to identify the color chip that is the closest match to the color of the article. The user may then identify the coating formulation that corresponds to the selected color chip and apply that coating formulation to the article as part of a refinishing process. As used herein, the term “refinish” refers to the act of redoing, restoring or repairing the surface or finish of an article or, in the case of automobile repairs, for example, the preparation of the surface or finish of an article in connection with such a repair.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A tool for matching the color of a coating on an article comprising:
(a) a color chip comprising a coating exhibiting gonio-apparent properties; and
(b) a window disposed directly adjacent to at least one side of the color chip, wherein the window has a length at least 50% that of the adjacent side of the color chip.

2. The tool of claim 1, wherein the coating exhibiting gonio-apparent properties comprises a metallic effect pigment.

3. The tool of claim 2, wherein the metallic effect pigment comprises aluminum, zinc, copper, brass, lead, bronze, and/or stainless steel.

4. The tool of claim 1, wherein the coating exhibiting gonio-apparent properties comprises an interference pigment.

5. The tool of claim 1, wherein the color chip is in the form of a square or rectangle.

6. The tool of claim 1, wherein the window has a length at least 75% that of the adjacent side of the color chip.

7. The tool of claim 6, wherein the window has a length at least 90% that of the adjacent side of the color chip.

8. The tool of claim 7, wherein the window has a length at least 100% that of the adjacent side of the color chip.

9. A paint chip book comprising one or more pages comprising a plurality of the color tools of claim 1 deposited upon a substrate.

10. The paint chip book of claim 9, wherein the substrate is grey paper.

11. A method for matching the color of a coating on an article comprising:
(a) placing a color tool against a surface of the article, the color tool comprising:
(i) a color chip comprising a coating exhibiting gonio-apparent properties; and
(ii) a window disposed directly adjacent to at least one side of the color chip, wherein the window has a length at least 50% that of the adjacent color chip side; and
(b) observing the color of the article through the window at a plurality of viewing angles.

12. The method of claim 11, further comprising:
(c) identifying the color chip that is the closest match to the color of the article.

13. The method of claim 12, further comprising:
(d) identifying the coating formulation that corresponds to the selected color chip.

14. The method of claim 13, further comprising:
(e) applying the identified coating formulation to the article.

15. The method of claim 11, wherein the coating exhibiting gonio-apparent properties comprises a metallic effect pigment.

16. The method of claim 15, wherein the metallic effect pigment comprises aluminum, zinc, copper, brass, lead, bronze, and/or stainless steel.

17. The method of claim 11, wherein the color chip is in the form of a square or rectangle.

18. The method of claim 11, wherein the window has a length at least 75% that of the adjacent side of the color chip.

19. The method of claim 18, wherein the window has a length at least 90% that of the adjacent side of the color chip.

20. The method of claim 19, wherein the window has a length at least 100% that of the adjacent side of the color chip.
